(19) United States
(12) Patent Application Publication
(10) Pub. No.: US 2010/0227152 A1
(43) Pub. Date: Sep. 9, 2010

(54) LAMINATED RESIN MOLDING, ITS MANUFACTURING METHOD, AND ITS MANUFACTURING APPARATUS

(75) Inventors: Ryutaro Nishibori, Shinagawa-ku (JP); Toshio Kazami, Utsunomiya-shi (JP); Minoru Shimojima, Utsunomiya-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD, Minato-ku ,Tokyo (JP)

(21) Appl. No.: 12/676,838

(22) PCT Filed: Sep. 1, 2008
(86) PCT No.: PCT/JP2008/065644

§ 371 Date: Mar. 5, 2010

(30) Foreign Application Priority Data
Sep. 20, 2007 (JP) 2007-244105
Sep. 20, 2007 (JP) 2007-244106
Sep. 20, 2007 (JP) 2007-244107

(51) Int. Cl. B32B 3/26; B29C 45/14

(52) U.S. Cl. 428/316.6; 264/279; 425/149

(57) ABSTRACT

Provided is a molding apparatus or an apparatus for manufacturing a laminated resin molding, which is composed of a female mold, a first horizontal mold, a second horizontal mold and a male mold, and these components form a cavity. This cavity includes a horizontal portion extending in a horizontal direction, and a first vertical portion and a second vertical portion, which rise substantially vertically from the horizontal portion. The first vertical portion has a vertical size set larger than that of the second vertical portion. In the male mold, an injector is disposed at a portion corresponding to the substantially central portion of the horizontal portion, and an air supply pipe is disposed at a portion corresponding to the second vertical portion. When a raw material is injected from the injector so as to execute the laminated resin molding manufacturing method, a gas such as compressed air is introduced through the air supply pipe into the second vertical portion, so that the raw material is pushed by that gas to the side of the first vertical portion.

### TECHNICAL FIELD

The present invention relates to a laminated resin molding, which is produced by providing a resin foam body on an end surface of a resin-made covering that has been formed to a predetermined shape and placed in a cavity defined by molds. The present invention further relates to a method of manufacturing such a laminated resin molding, and to an apparatus for manufacturing such a laminated resin molding.

### BACKGROUND ART

Instrument panels for use in automobiles, for example, comprise a laminated body including a base layer made of a resin material, an intermediate layer comprising a resin foam body with air bubbles dispersed substantially uniformly therein, and a covering layer made of a resin material, the layers being joined together in this order. Since the intermediate layer comprises a resin foam body, the laminated body is soft for providing an excellent cushioning sensation.

A laminated body of this type is manufactured by first stacking the intermediate layer on one end surface of the covering layer in order to produce a laminated resin molding, and then joining the intermediate layer of the laminated resin molding and a separately fabricated base layer to each other, while shaping them in a vacuum forming machine.

The laminated resin molding is fabricated by providing a resin foam body on an end surface of a covering layer that has been formed to a predetermined shape and inserted in a cavity defined by molds (see, for example, Patent Document 1). More specifically, the cavity with the covering layer inserted therein is simultaneously supplied with a base compound and a curing agent as raw materials for the resin foam body. The base compound is cured when brought into contact with the curing agent.

The base compound contains a foaming agent. When the molds, which are filled with the base compound and the curing agent, are heated, the base compound is foamed by the foaming agent. The intermediate layer is produced when the foamed base compound is cured.

If air bubbles in the foamed resin are closed cells, then the laminated body is resistant to being deformed when pressed. Therefore, it has been customary to perform a defoaming process for joining closed cells together into open cells. For example, Patent Document 2 discloses a conventional technique for defoaming a molding comprising a resin foam body by compressing the molding. Further, according to Patent Document 3, it has been proposed to defoam a molding, which comprises a resin foam body, by diffusing compressed air into the molding.

Instrument panels for use in automobiles or the like are required to have a certain region that is of a higher hardness than other regions, or stated otherwise, to have regions of different hardness. The method disclosed in Patent Document 4 is known as a conventional technique for fabricating such an instrument panel.

Patent Document 1: Japanese Patent No. 3698660

Patent Document 2: Japanese Utility Model Publication No. 03-010026

Patent Document 3: Japanese Patent Publication No. 06-018924

Patent Document 4: Japanese Laid-Open Patent Publication No. 01-110913

### DISCLOSURE OF THE INVENTION

For defoaming the intermediate layer (resin foam body) stacked on the end surface of the covering layer after the laminated body is produced, the conventional vacuum depressurization technique disclosed in Patent Document 2 may be employed. According to the disclosed process, a laminated resin molding is removed from the molds, and then the pressure around the laminated resin molding is reduced.

When the pressure around the laminated resin molding is reduced, since the pressure in each of the closed cells becomes higher than the pressure around the laminated resin molding, minute cracks are developed from portions of the closed cells. When such cracks are joined together, open cells are produced. Since some of the cracks extend to the surface of the resin foam body, atmospheric air finds its way into the open cells.

Thereafter, the laminated resin molding is inserted back into the molds. The molds are then closed, and the cavity is evacuated, discharging the atmospheric air that has entered the air bubbles.

However, the above process of opening the molds, defoaming the intermediate layer, and then closing the molds is complex and time-consuming.

Furthermore, when open cells are formed by reducing the pressure around the laminated resin molding after it has been removed from the molds, the laminated resin molding is inevitably deformed (dimensionally deformed), since no frame is present for restraining the laminated resin molding. The laminated resin molding, which has become dimensionally deformed, is returned into the molds, and then the cavity is evacuated as described above. However, inasmuch as the laminated resin molding is not corrected, the dimensional accuracy thereof is not high.

Therefore, the method of manufacturing the laminated resin molding according to the conventional art requires a complex process of producing open cells, is low in production efficiency, and does not achieve high dimensional accuracy.

According to the conventional technique disclosed in Patent Document 4, in order to produce an instrument panel including regions of different hardness, polyurethanes with different amounts of a curing agent added thereto are prepared, and a wall is provided in a cavity to prevent the different polyurethanes from becoming mixed with each other. In other words, a certain compartment is filled with one polyurethane for producing a resin foam body of a higher hardness, whereas another compartment is filled with a different polyurethane for producing a resin foam body having a lower hardness.

However, preparing a plurality of different kinds of raw materials is complex, and there is a concern that a worker might mistake the raw material to achieve the higher hardness and the raw material to achieve the lower hardness for each other during filling of the compartments. Moreover, the wall makes the molding assembly complicated in shape, resulting in an increased investment for equipment.

In addition, instrument panels for use in automobiles or the like are complex in shape, and thus the cavity for molding the laminated resin molding also is complex in shape. The cavity includes an area that can easily be filled, i.e., an area that is filled with the base compound and the curing agent (the raw material of the resin foam body) at a higher filling rate, because the base compound and the curing agent are easily flowable therein. The cavity also includes another area that is filled with the base compound and the curing agent at a lower filling rate, because the base compound and the curing agent are relatively hard to flow therein.

If the filling rates are greatly different from each other in the same cavity, then the area with the lower filling rate may not be filled with the base compound and the curing agent, and the base compound may become cured without filling the area. A laminated resin molding which is produced thereby obviously is defective, since it lacks a part thereof.

To avoid the above difficulty, the base compound that is brought into contact with the curing agent may be cured at a reduced rate, or alternatively, the base compound and the curing agent may be supplied at a reduced rate into the cavity. However, these solutions prolong the tact time needed to complete fabrication of the laminated resin molding. If an initial filling rate is increased, or stated otherwise, in order to shorten the tact time, if the rate at which the injection machines supply the base compound and the curing agent per unit time is increased, then other problems tend to arise.

As described above, it is apparent that the method of manufacturing the laminated resin molding according to the conventional art is problematic, in that filling the entire cavity efficiently with the raw material of the resin foam body (intermediate layer) is difficult, and hence it is difficult to increase the efficiency with which laminated resin moldings are produced.

It is a general object of the present invention to provide a method of simply and efficiently manufacturing a sufficiently soft laminated resin molding.

A major object of the present invention is to provide a method of efficiently manufacturing a laminated resin molding with increased yield.

Another object of the present invention is to provide a method of efficiently manufacturing a laminated resin molding, which includes regions of different hardness therein.

Still another object of the present invention is to provide an apparatus for manufacturing a laminated resin molding, which includes regions of different hardness therein.

Yet another object of the present invention is to provide a laminated resin molding, which includes regions of different hardness therein.

According to an embodiment of the present invention, there is provided a method of manufacturing a laminated resin molding by providing a resin foam body on an end surface of a resin-made molding that has been formed to a predetermined shape, and which is placed in a cavity defined by molds, comprising:
supplying a gas to the cavity to press a raw material supplied thereto from supply means while the supplied raw material flows into the cavity; and
reducing the pressure of the gas to defoam the raw material while the raw material undergoes foaming.

According to the present invention, the gas is supplied in order to limit flowing movement of the raw material (e.g., a base compound and a curing agent) of the resin foam body. The gas forms a pseudo-shell surrounding the raw material, which is pressed in the shell. Therefore, the pressure in the closed cells produced in the raw material and the pressure of the supplied gas are held in equilibrium with each other.

When the pressure of the gas is reduced while the raw material is continuously foamed, the shell is removed from the raw material. As a result, the pressure in the closed cells becomes higher than the pressure surrounding the raw material, causing cracks to develop in the closed cells. The cracks are then joined together, forming open cells.

According to the present invention, therefore, open cells can be produced without the need for a complex subsequent process, such as vacuum depressurization or the like, after the laminated resin molding has been formed. Consequently, the operation sequence is simplified and the time required to produce the laminated resin molding is greatly shortened.

The laminated resin molding thus fabricated is softer and offers a better cushioning feel than a laminated resin molding having open cells therein, which is produced by a known defoaming process, such as vacuum depressurization or the like.

According to the present invention, as described above, the soft laminated resin molding can efficiently be manufactured by a simple process of supplying gas in a direction to limit flowing movement of the raw material, and by reducing the pressure of the gas while the raw material undergoes foaming.

Preferably, the gas is initially supplied under a pressure capable of stopping the raw material from flowing. With such a pressure setting, since the raw material can reliably be encased by the shell, it is easier to produce open cells therein.

Accordingly, a subsequent process to produce open cells, such as vacuum depressurization or the like, is not necessary. Consequently, the manufacturing operation of the laminated resin molding is simplified and the laminated resin molding can efficiently be manufactured.

According to another embodiment of the present invention, there is also provided a method of manufacturing a laminated resin molding by providing a resin foam body on an end surface of a resin-made molding that has been formed to a predetermined shape, and which is placed in a cavity defined by molds, comprising the steps of:
using the cavity as the molds, the cavity including a first portion into which a raw material of the resin foam body flows from a location where supply means for supplying the raw material to the cavity is disposed, and a second portion into which the raw material flows from the location in a direction different from the direction in which the raw material flows into the first portion, the raw material having a higher filling rate in the second portion than in the first portion;
supplying a gas to the second portion to press the raw material flowing into the second portion when the raw material is supplied from the supply means, thereby limiting flowing movement of the raw material in the second portion; and
stopping the gas from being supplied after the first portion has been filled with the raw material.

According to the present invention, the gas is supplied from the second portion of the cavity, in which the filling rate of the raw material (e.g., a base compound and a curing agent) of the resin foam body is higher, for thereby limiting flowing movement of the raw material. The raw material is pressed toward the supply means by the gas, and ultimately flows into the first portion. Stated otherwise, the filling rate of the raw material in the first portion is increased in order to accelerate filling of the first portion with the raw material.

According to the present invention, therefore, the first portion, in which the filling rate of the raw material is low, can be filled efficiently with the raw material. Consequently, the laminated resin molding can be formed efficiently.

The gas is continuously supplied until the first portion is filled with the raw material (the time required until the first portion is filled with the raw material is determined in advance by tests conducted with raw materials having various viscosities, various pressures for supplying the raw material, and various pressures for supplying the gas). Therefore, a laminated resin molding, which is free of vacant portions therein, can be produced. Stated otherwise, a laminated resin molding can be manufactured with increased yield.

The pressure for supplying the gas may be reduced stepwise or continuously while the first portion is filled with the raw material. With such a pressure setting, the pressing force acting on the raw material, which has flowed into the second portion, is reduced. Therefore, while the first portion is filled with the raw material, the filling rate of the raw material into the second portion can be increased. Since the second portion can be filled efficiently with the raw material, the efficiency at which the laminated resin molding is produced is increased.

Since filling of the first portion with the raw material is accelerated, it is possible to efficiently manufacture a laminated resin molding, which is free of vacant portions therein. Accordingly, the manufacturing yield can be increased.

According to still another embodiment of the present invention, there is further provided a method of manufacturing a laminated resin molding by providing a resin foam body on an end surface of a resin-made molding that has been formed to a predetermined shape and placed in a cavity defined by molds, comprising:
while a raw material for the resin foam body is supplied by supply means, supplying a gas to the cavity from a direction that limits flowing movement of the raw material to press the raw material.

According to the present invention, the gas is supplied in order to limit flowing movement of the raw material (e.g., a base compound and a curing agent), and to press the raw material toward the supply means. Consequently, within a region of the raw material that is close to the gas supply means, flowing movement of the raw material is delayed, and air bubbles produced when the raw material is foamed grow to a large size.

On the other hand, the time required after the raw material is introduced through the supply means into the cavity and until the introduced raw material is cured is shorter on the side of the raw material supply means. Therefore, as described above, whereas air bubbles in a region of the raw material close to the gas supply means grow large in size, air bubbles in another region of the raw material, which is close to the raw material supply means, remain small in size.

In other words, the air bubbles in the raw material are progressively smaller in size from the gas supply means toward the raw material supply means. The region in which the air bubbles have grown large in size is smaller in rigidity and softer because the porosity thereof is larger. In contrast, the region in which the air bubbles are small in size is of a smaller porosity, and hence is larger in rigidity and harder. Stated otherwise, the region in which the air bubbles have grown large in size is lower in rigidity, whereas the region in which the air bubbles are small in size is higher in rigidity.

According to the present invention, as can be understood from the foregoing, a highly simple process of supplying gas in a direction to limit flowing movement of the raw material is carried out in order to grow air bubbles at different degrees, thereby efficiently forming a laminated resin molding having regions of different hardness therein. The relationship between the pressure at which the gas is supplied and the degree of growth of the air bubbles may be determined in advance by tests conducted using raw materials having various viscosities, various pressures for supplying the raw material, and various pressures for supplying the gas.

The pressure for supplying the gas may be changed (increased or reduced) stepwise or continuously while the cavity is filled with the raw material. When the pressure for supplying the gas is reduced, the pressing force applied to the raw material by the gas is reduced, thereby accelerating the rate at which the raw material is filled into the cavity. Conversely, when the pressure for supplying the gas is increased, since the flowing movement of the raw material is further limited, the filling rate is reduced, or filling of the raw material is stopped in some cases. When the filling rate of the raw material is thus increased or reduced, the air bubbles can easily be controlled at a desired size, and hence the laminated resin molding can be adjusted to a desired hardness.

According to yet another embodiment of the present invention, there is also provided an apparatus for manufacturing a laminated resin molding by providing a resin foam body on an end surface of a resin-made molding that has been formed to a predetermined shape, and which is placed in a cavity defined by molds, comprising:
raw material supply means for supplying a raw material of the resin foam body;
gas supply means for supplying a gas to the cavity in a direction to limit flowing movement of the raw material while the raw material is supplied;
gas pressure changing means for changing a pressure of the gas which is supplied from the gas supply means; and
control means for instructing the gas pressure changing means to change the pressure.

With the above arrangement, the gas is supplied in a direction to limit flowing movement of the raw material of the resin foam body. As a result, it is possible to easily produce a laminated resin molding, including a region in which air bubbles generated when the raw material is foamed are grown to a large size.

The air bubbles in the resin foam body of the laminated resin molding can be grown at different degrees in different regions of the resin foam body. As a result, the hardness of the laminated resin molding can be made different in different regions thereof.

According to yet still another embodiment of the present invention, there is also provided a laminated resin molding including a laminated stack of a base layer made of a resin material, an intermediate layer made of a resin foam body, and a covering layer made of a resin material, wherein
the intermediate layer is made of the same resin in its entirety;
the intermediate layer includes a first region including large air bubbles, and a second region including small air bubbles which are smaller in volume than the large air bubbles;
the first region and the second region extend along a direction in which the raw material flows; and
the first region is softer than the second region.

According to the present invention, therefore, a laminated resin molding is constructed, which includes an intermediate layer made of the same resin, and further which includes a softer region and a harder region therein.

### BRIEF DESCRIPTION OF THE DRAWINGS

FIG. 1 is a vertical cross-sectional view of a molding apparatus for carrying out a method of manufacturing a laminated resin molding according to a first embodiment of the present invention;

FIG. 2 is a vertical cross-sectional view showing the manner in which compressed air is introduced through a second lateral mold into the cavity of the molding apparatus shown in FIG. 1, while the cavity undergoes filling with a raw material of a resin foam body;

FIG. 3 is a vertical cross-sectional view showing the manner in which filling of the cavity with the raw material is completed, thereby producing a laminated resin molding;

FIG. 4 is a fragmentary enlarged vertical cross-sectional view showing at an enlarged scale the manner in which cracks developed within closed cells are joined together, thereby producing open cells;

FIG. 5 is a vertical cross-sectional view of a molding apparatus according to a second embodiment of the present invention;

FIG. 6 is a vertical cross-sectional view showing the manner in which compressed air is introduced from a second vertical portion into the cavity of the molding apparatus shown in FIG. 5, while the cavity undergoes filling with a raw material of a resin foam body;

FIG. 7 is a vertical cross-sectional view showing the manner in which filling of the raw material into a first vertical portion is completed, whereas the second vertical portion is still being filled with the raw material;

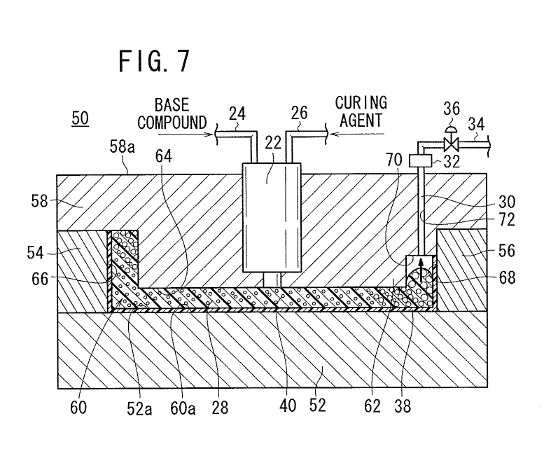

FIG. 8 is a vertical cross-sectional view showing the manner in which filling of the cavity with the raw material is completed, thereby producing a laminated resin molding; and

FIG. 9 is a perspective view of the produced laminated resin molding.

### BEST MODE FOR CARRYING OUT THE INVENTION

Preferred embodiments of a laminated resin molding according to the present invention, in relation to methods and apparatus for manufacturing the laminated resin molding, will be described in detail below with reference to the accompanying drawings.

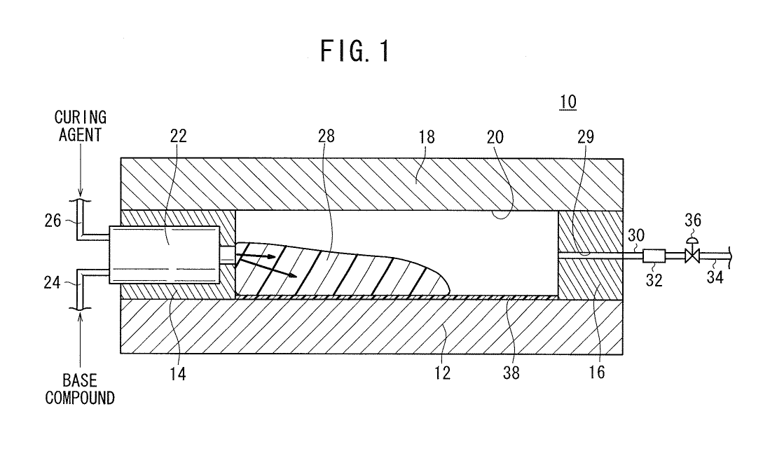

FIG. 1 is a vertical cross-sectional view of a molding apparatus (manufacturing apparatus) 10 for carrying out a method of manufacturing a laminated resin molding according to a first embodiment of the present invention. The molding apparatus 10 has a lower mold 12, a first lateral mold 14, a second lateral mold 16, and an upper mold 18, which serve as forming molds. Displacing mechanisms (e.g., a fluid pressure cylinder or the like) are connected to each of the molds 12, 14, 16, 18. The lower mold 12, the first lateral mold 14, the second lateral mold 16, and the upper mold 18 are movable toward and away from each other by the displacing mechanisms. When the lower mold 12, the first lateral mold 14, the second lateral mold 16, and the upper mold 18 are moved toward each other, the molds are closed to form a cavity 20. When the lower mold 12, the first lateral mold 14, the second lateral mold 16, and the upper mold 18 are moved away from each other, the molds are opened.

The cavity 20 extends horizontally. The first lateral mold 14 incorporates therein an injecting machine 22 serving as a supply means for supplying a base compound and a curing agent, which collectively make up the raw material of a resin foam body. The injecting machine 22 is connected to a base compound supply pipe 24 for supplying the base compound into cavity 20 and a curing agent supply pipe 26 for supplying the curing agent, which is added to the base compound. The base compound and the curing agent are mixed together in the injecting machine 22, and are supplied as the raw material 28 from the injecting machine 22 into the cavity 20.

The second lateral mold 16 has a through hole 29 therein, extending along the direction in which the cavity 20 extends. An air delivery pipe 30 is inserted in the through hole 29. The air delivery pipe 30 has a distal end portion that projects from a side surface of the second lateral mold 16 and is connected to a gas supply pipe 34 through a regulator 32. The gas supply pipe 34 is connected to a gas supply source, not shown, and includes a valve 36.

The regulator 32 is combined with an actuator, not shown, for actuating the regulator 32, and an actuator control means, not shown, for controlling the actuator.

The valve 36 is connected to a valve opening control means (not shown) for controlling the opening degree of the valve 36 through an electric or optical communication means (not shown). Opening of the valve 36 can be changed stepwise or continuously by a command signal from the valve opening control means.

The actuator control means and the valve opening control means are provided as a control circuit on a single control panel, which controls the operation sequence of the molding apparatus 10.

Each of the lower mold 12, the first lateral mold 14, the second lateral mold 16, and the upper mold 18 has a plurality of discharge passages defined therein (not shown). A covering layer 38, which is made of a resin material and shaped complementarily to the shape of an upper end surface of the lower mold 12, is inserted in the cavity 20.

The method of manufacturing a laminated resin molding according to the first embodiment of the present invention is carried out in the following manner using the molding apparatus 10 thus constructed.

First, a base compound is supplied to the injecting machine 22 from the base compound supply pipe 24, and a curing agent is supplied from the curing agent supply pipe 26. The injecting machine 22 mixes the base compound and the curing agent together and thereafter supplies the mixture as a raw material 28 into the cavity 20. While the raw material 28 fills the cavity 20, atmospheric air that remains in the cavity 20 is forced out of the cavity 20 by the raw material 28 and is discharged through the discharge passages.

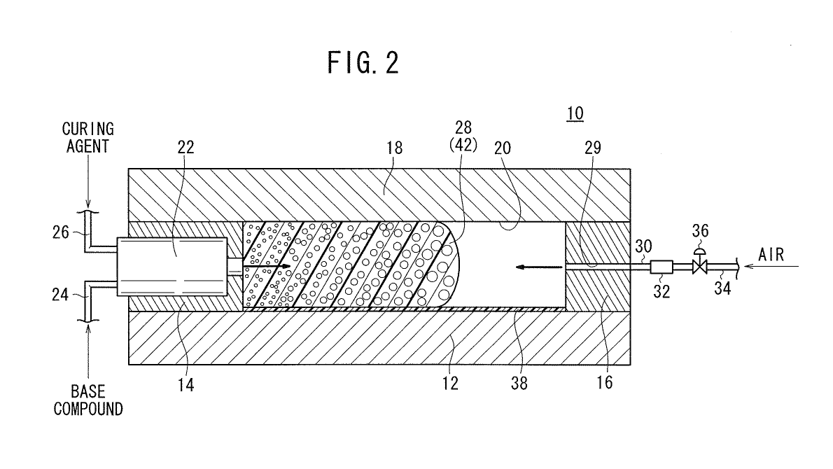

According to the first embodiment, as shown in FIG. 2, immediately after the raw material 28 has begun to fill the cavity 20, or after a given amount of raw material 28 has been introduced, compressed air is introduced into the cavity 20 from the gas supply source through the gas supply pipe 34 and the air delivery pipe 30. Nitrogen, argon, or the like may be introduced instead of compressed air.

The compressed air is introduced in a direction opposed to the direction in which the raw material 28 flows. Therefore, the raw material 28 is pressed by the compressed air, in a direction opposed to the direction in which the raw material 28 flows. As a result of the compressed air from the second lateral mold 16, the filling rate of the raw material 28 is reduced.

A foaming agent contained within the base compound of the raw material foams to produce air bubbles 40, while the base compound starts to be cured by the curing agent. During this time, raw material 28 begins to change into a resin foam body 42. The raw material 28 begins to change from a region thereof which has initially been introduced into the cavity 20, i.e., a region thereof which is close to the second lateral mold 16.

According to the first embodiment, as described above, the compressed air is introduced from the second lateral mold 16. Therefore, since the region of the raw material 28 (resin foam body 42) which is close to the second lateral mold 16 is pressed by the compressed air in order to delay flowing movement thereof, the air bubbles 40 grow within that region.

On the other hand, the region of the raw material 28 (resin foam body 42) which is close to the first lateral mold 14 has just been introduced from the injecting machine 22 into the cavity 20 and has resided therein only for a short period of time. Therefore, while the air bubbles 40 in the region close to the second lateral mold 16 grow large in size, the air bubbles 40 in the region close to the first lateral mold 14 remain small in size. Accordingly, air bubbles 40 are formed which are progressively smaller in size from the second lateral mold 16 toward the first lateral mold 14. Stated otherwise, the air bubbles 40 contained within the raw material 28 (resin foam body 42) have different sizes near the second lateral mold 16 and near the first lateral mold 14, respectively.

While the air bubbles 40 have different sizes near the second lateral mold 16 and the first lateral mold 14, respectively, the raw material 28 is progressively cured to form the resin foam body 42. When the resin foam body 42 is formed, the air bubbles 40 in the region close to the second lateral mold 16 have grown large in size, whereas the air bubbles 40 in the region close to the first lateral mold 14 remain small in size.

Finally, the cavity 20 is filled with the raw material 28 (resin foam body 42). The resin foam body 42 is joined to the covering layer 38, whereupon a laminated resin molding 44 is produced having the resin foam body 42 (intermediate layer) stacked on the covering layer 38. Thereafter, the displacing mechanisms are operated to displace the lower mold 12, the first lateral mold 14, the second lateral mold 16, and the upper mold 18 away from each other, whereupon the molds are opened to expose the laminated resin molding 44.

The laminated resin molding 44 is then sent to a vacuum forming machine, which stacks a base layer on the resin foam body 42, and shapes the laminated resin molding 44 and the base layer into a final product, such as an instrument panel for automobiles or the like. Because the region containing large air bubbles is low in rigidity, the final product is soft in a region thereof where the air bubbles 40 have grown large in size, and hard in a region thereof where the air bubbles 40 are small in size.

As described above, a gas such as compressed air or the like is introduced in a direction to limit flowing movement of the raw material 28 (resin foam body 42) in order to delay the raw material 28 as it fills the cavity 20. During this time, the air bubbles 40 grow large in size in the region of the raw material 28 (resin foam body 42) that is held in contact with the gas. In this manner, a laminated resin molding 44, which includes regions of different hardness, is easily produced.

Since it is not necessary to perform a complex process of preparing a plurality of different kinds of raw materials, and further since there is no need for walls in the cavity, the equipment costs and investment for equipment are not increased.

If the raw material 28 were simply introduced to fill the cavity 20 without limiting flowing movement thereof, then the raw material 28 (resin foam body 42) would reach the second lateral mold 16, thereby filling the cavity 20 within a relatively short period of time. The base compound and the curing agent of the raw material 28 are mixed with each other, and as a predetermined time elapses, the base compound begins to be cured by the curing agent, until finally curing thereof is completed. If the filling of the cavity 20 with the raw material 28 is completed within a short period of time, as described above, then the amount of the raw material 28 that fills the cavity 20 becomes greater than in the first embodiment, in which flowing movement of the raw material 28 is limited. Furthermore, inasmuch as the time required after filling is completed and until curing is finished occurs over a longer period than in the present embodiment, the air bubbles 40 close to the injecting machine 22 side grow to be large in size as well. Consequently, the air bubbles 40 become essentially uniform in size throughout the entire cavity 20.

While the raw material 28 fills the cavity 20, the regulator 32 may be operated by a command signal from the actuator control means in order to increase or reduce the pressure of the compressed air, for thereby increasing or reducing the filling rate of the raw material 28. More specifically, when the pressure at which the compressed air is supplied is reduced, since the pressing force acting on the raw material 28 is reduced, filling of the cavity 20 with the raw material 28 is accelerated. Conversely, when the pressure at which the compressed air is supplied is increased, since flowing movement of the raw material 28 is further limited, the filling rate is reduced, or in some instances, filling of the raw material 28 may be stopped.

Accordingly, it is possible to control the size of the air bubbles 40 to a desired size. Specifically, when the filling rate of the raw material 28 is reduced, the air bubbles 40 in the region close to the second lateral mold 16 grow greater in size. When the raw material 28 is stopped, the air bubbles 40 in the region close to the second lateral mold 16 also grow larger in size.

The pressure may be increased or reduced stepwise or continuously.

According to the first embodiment, as described above, the laminated resin molding 44, which includes regions of different hardness therein, is easily produced at a low cost.

The air bubbles 40 in the resin foam body 42 can be produced as open cells by introducing compressed air. Details of this process will be described below.

According to the present embodiment, as described above, compressed air is introduced from the second lateral mold 16. Consequently, the raw material 28 (resin foam body 42) flows at a reduced rate, or stops flowing altogether. Therefore, the raw material 28 (resin foam body 42) is surrounded by compressed air. Stated otherwise, the raw material 28 (resin foam body 42) is encased within a compressive pseudo-shell made up of compressed air. The raw material 28 (resin foam body 42), which is encased in this manner, continues to undergo foaming. Therefore, the pressure in the produced closed shells is kept in equilibrium with the pressure of the pseudo-shell (compressed air).

While the raw material 28 (resin foam body 42) continues to foam, the regulator 32 is operated to reduce the pressure at which the compressed air is supplied, i.e., to depressurize the compressed air.

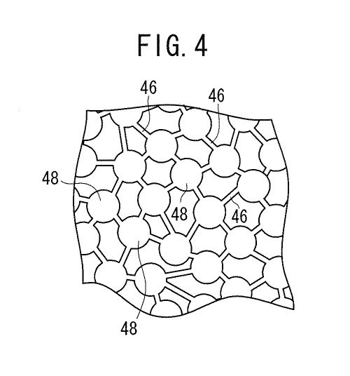

When the compressed air is depressurized, the pseudo-shell, which has encased the raw material 28 (resin foam body 42), is removed. As a result, the pressure in the closed shells becomes higher than the pressure in the cavity 20, so that cracks 46 are developed from the closed cells, as shown in FIG. 4. The cracks 46 eventually are joined together, thereby producing open cells 48. At the same time, the cavity 20 becomes entirely filled with the raw material 28, which changes into the resin foam body 42. The resin foam body 42 is joined to the covering layer 38, whereupon a laminated resin molding 44 is produced having the resin foam body 42 (intermediate layer) stacked on the covering layer 38.

As described above, during filling of the cavity 20 with the raw material 28, compressed air is supplied into the cavity 20, and while the raw material 28 undergoes foaming continuously, the pressure of the compressed air is reduced in order to produce open cells 48 as the resin foam body 42 is formed from the raw material 28.

Thereafter, the displacing mechanisms are operated to displace the lower mold 12, the first lateral mold 14, the second lateral mold 16, and the upper mold 18 away from each other. The molds are opened to expose the laminated resin molding. Since open cells 48 already have been formed in the resin foam body 42 of the laminated resin molding, unlike the conventional technology, vacuum depressurization does not need to be carried out.

According to the first embodiment, therefore, complex subsequent processes (vacuum depressurization, etc.) for forming open cells 48 do not need to be performed. Thus, the time required to produce the laminated resin molding is greatly shortened. Further, the laminated resin molding, as fabricated by the manufacturing method according to the first embodiment, is softer and provides an excellent cushioning feel, better than a laminated resin molding having open cells therein which are produced by a known defoaming process, such as vacuum depressurization or the like.

The laminated resin molding is then transferred to a vacuum forming machine, which stacks a base layer on the resin foam body 42 and shapes the laminated resin molding 44 and the base layer into a final product, such as an instrument panel for automobiles or the like. The final product also provides an excellent cushioning feel.

According to the first embodiment, therefore, a softer laminated resin molding can be manufactured simply and efficiently.

The initial pressure of the compressed air or the like when the compressed air starts to be supplied is not limited to being at a high level which is sufficient to stop the raw material 28. The compressed air may be of a level which at least delays flowing movement of the raw material 28.

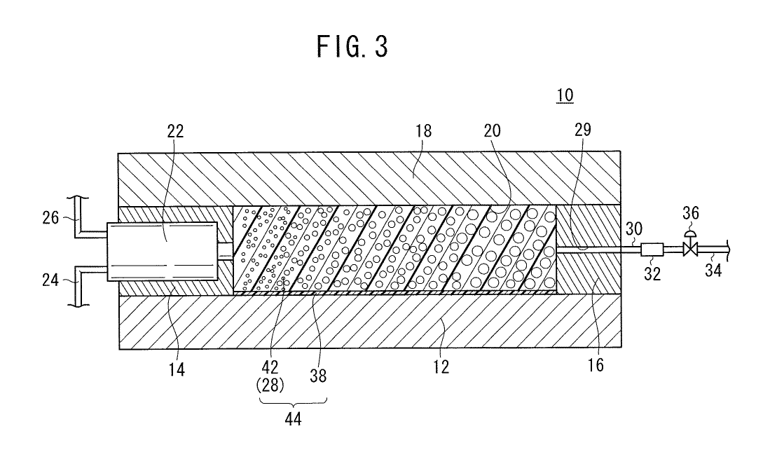

A molding apparatus 50 according to a second embodiment of the present invention, in which the raw material 28 branches and flows in different directions from a position where the injecting machine 22 is located, will be described below by way of example. Components of the molding apparatus 50, which correspond to similar components shown in FIGS. 1 through 3, are denoted by identical reference characters, and such features will not be described below.

The molding apparatus 50 includes a lower mold 52, a first lateral mold 54, a second lateral mold 56, and an upper mold 58, which serve as forming molds. As with the molds 12, 14, 16, 18, the lower mold 52, the first lateral mold 54, the second lateral mold 56, and the upper mold 58 are movable toward and away from each other by displacing mechanisms (not shown) such as fluid pressure cylinders or the like. When the lower mold 52, the first lateral mold 54, the second lateral mold 56, and the upper mold 58 are moved toward each other, the molds are closed to form a cavity 60. Conversely, when the lower mold 52, the first lateral mold 54, the second lateral mold 56, and the upper mold 58 are moved away from each other, the molds are opened.

A land 62 projects vertically downward from the bottom surface of the upper mold 58, which faces the cavity 60 in confronting relation to inner wall surfaces of the first lateral mold 54 and the second lateral mold 56, which extend vertically. The cavity 60, which is formed when the lower mold 52, the first lateral mold 54, the second lateral mold 56, and the upper mold 58 are closed, includes a horizontal portion 64 that extends along a horizontal upper end surface 52a of the lower mold 52, and a first vertical portion 66 and a second vertical portion 68, each of which rises from the horizontal portion 64 substantially vertically along the first lateral mold 54 and the second lateral mold 56.

The land 62 has a step 70 on a wall thereof that faces the second lateral mold 56. The step 70 is held in abutment against the inner wall surface of the second lateral mold 56. Because of the step 70, the vertical dimension of the second vertical portion 68 is smaller than the vertical dimension of the first vertical portion 66.

The upper mold 58 incorporates therein an injecting machine 22 connected to a base compound supply pipe 24 for supplying the horizontal portion 64 of the cavity 60 with a base compound, and a curing agent supply pipe 26 for supplying a curing agent, which is added to the base compound. The base compound and the curing agent are mixed together in the injecting machine 22, and supplied as a raw material 28 from the injecting machine 22 to the horizontal portion 64.

The upper mold 58 has a through hole 72 defined therein, which extends from an upper end surface 58a thereof to the step 70. An air delivery pipe 30 is inserted in the through hole 72. The air delivery pipe 30 has a distal end portion that projects from the upper end surface 58a of the upper mold 58, and which is connected to a gas supply pipe 34 through a regulator 32. The gas supply pipe 34 is connected to a gas supply source, not shown, and has a valve 36.

As described above, the regulator 32 is combined with an actuator, not shown, for actuating the regulator 32, and an actuator control means, not shown, for controlling the actuator.

The valve 36 is connected to a valve opening control means (not shown) for controlling the opening degree of the valve 36 through an electric or optical communication means (not shown). Opening of the valve 36 can be changed stepwise or continuously by a command signal from the valve opening control means.

The actuator control means and the valve opening control means are provided as a control circuit on a single control panel, which controls the operation sequence of the molding apparatus 50.

Each of the lower mold 52, the first lateral mold 54, the second lateral mold 56, and the upper mold 58 has a plurality of discharge passages defined therein (not shown). A covering layer 38, which is made of a resin material and shaped complementarily to the shape of an end surface 60a that faces the horizontal portion 64, the first vertical portion 66, and the second vertical portion 68 of the cavity 60, is inserted in the cavity 60.

A method of manufacturing a laminated resin molding according to the second embodiment of the present invention is carried out in the following manner, using the molding apparatus 10 thus constructed.

First, the injecting machine 22 is supplied with a base compound from the base compound supply pipe 24 and a curing agent from the curing agent supply pipe 26. The injecting machine 22 mixes the base compound and the curing agent together and then supplies the mixture as a raw material 28 into the horizontal portion 64.

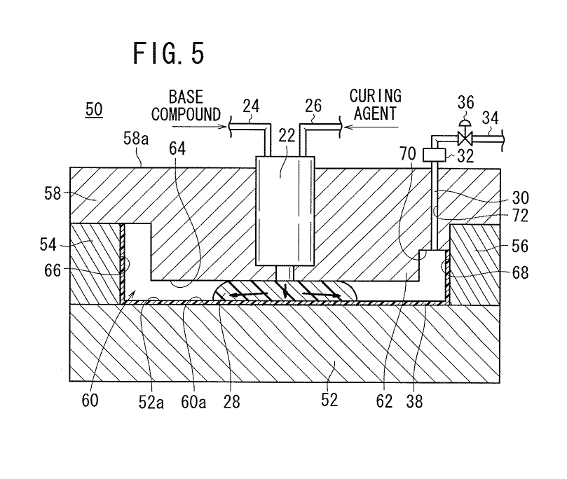

As indicated by the arrows in FIG. 5, the raw material 28 composed of the supplied base compound and the curing agent branches from the location where the raw material 28 is supplied from the injecting machine 22 into the horizontal portion 64. A portion of the raw material 28 flows toward the first vertical portion 66, whereas the remaining raw material 28 flows toward the second vertical portion 68.

If the raw material 28 were simply introduced to fill the cavity 20, the raw material 28 would fill the first vertical portion 66 and the second vertical portion 68 while flowing against gravity. Therefore, the raw material 28 would fill the first vertical portion 66, which is of a greater vertical dimension, at a lower rate than the rate at which the raw material 28 fills the second vertical portion 68. Thus, the cavity 60 would include a region therein (the second vertical portion 68) where the filling rate of the raw material 28 is greater, and another region (the first vertical portion 66) where the filling rate of the raw material 28 is smaller.

Although not shown in detail, if the cavity 60 is branched in layers, the cavity 60 may include a region where the filling rate is smaller, which corresponds to the first vertical portion 66.

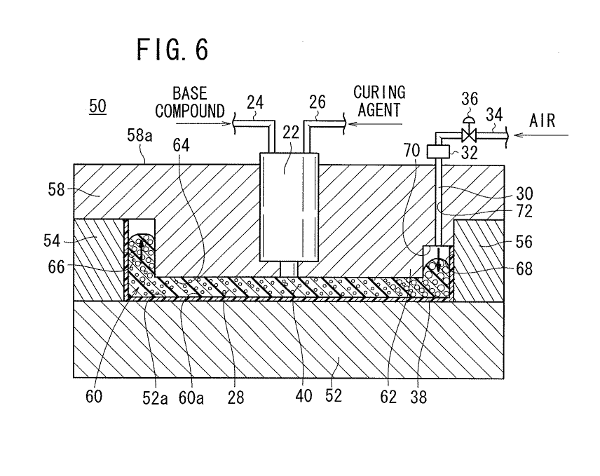

According to the second embodiment, as shown in FIG. 6, immediately after the raw material 28 has begun to fill the cavity 60, or after a given amount of raw material 28 has been introduced, compressed air is introduced into the second vertical portion 68 from the gas supply source through the gas supply pipe 34 and the air delivery pipe 30. Nitrogen, argon, or the like may be introduced instead of compressed air.

The raw material 28 that has flowed into the second vertical portion 68 is pressed by the compressed air, which is introduced and flows in a direction opposed to the direction in which the raw material 28 flows. Therefore, the raw material 28 is restricted from flowing into the second vertical portion 68, and the filling rate of the raw material 28 is reduced.

The raw material 28, which has been pressed from the second vertical portion 68 toward the first vertical portion 66, is accelerated and flows toward the first vertical portion 66. In the first vertical portion 66, therefore, the filling rate of the raw material 28 is much higher than if no compressed air were introduced from the second vertical portion 68. In addition, since the raw material 28 finds its way into the first vertical portion 66 without fail, the first vertical portion 66 is easily filled with the raw material 28. In other words, the first vertical portion 66 is filled efficiently with the raw material 28.

After the first vertical portion 66 has been filled with the raw material 28, the valve 36 is closed by a command signal from the valve opening control means, in order to stop the compressed air from being introduced. As a result, since the raw material 28 that flows into the second vertical portion 68 is no longer pressed, the interface of the raw material 28 in the second vertical portion 68 quickly rises, since the filling rate of the raw material 28 in the second vertical portion 68 increases.

While the raw material 28 fills the first vertical portion 66, the regulator 32 may be operated in order to reduce the pressure at which the compressed air is supplied. If the supply pressure for the compressed air is reduced, then since the pressing force on the raw material is reduced, filling of the second vertical portion 68 with the raw material 28 is accelerated. In other words, while the raw material 28 fills the first vertical portion 66, the second vertical portion 68 can also be filled efficiently with the raw material 28. The pressure may be reduced stepwise or continuously.

As described above, when a gas such as compressed air or the like is supplied to the cavity 60 in a direction to limit flowing movement of the raw material 28 from the injecting machine 22 and thereby to press on the raw material 28, flowing movement of a region of the raw material 28 which is close to the gas supply means is delayed, thus allowing air bubbles 40 generated by foaming to grow in size.

While the raw material 28 fills the cavity 60, any atmospheric air that remains in the cavity 60 is discharged out of the cavity 60 through the discharge passages as the atmospheric air is pressed by the raw material 28.

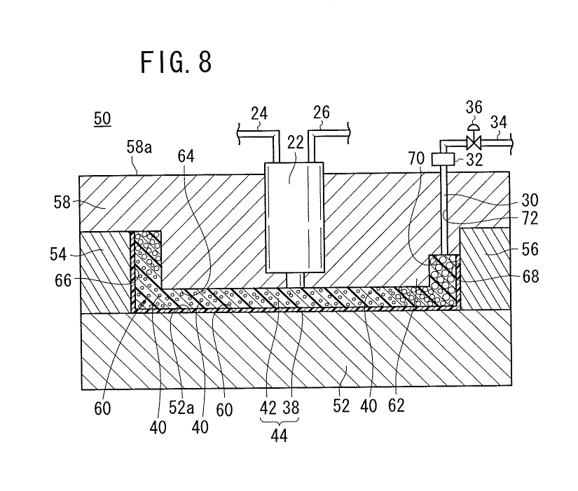

Finally, as shown in FIG. 8, the second vertical portion 68 is filled with the raw material 28. The forming molds are then heated in order to cause the base compound to foam in the presence of the foaming agent included in the base compound, and also to cause the raw material 28 to become fused to the covering layer 38. At the same time, the base compound is cured by the curing agent, whereupon a laminated resin molding 44 having the resin foam body 42 (intermediate layer) containing air bubbles 40 therein and which is stacked on the covering layer 38 is produced. The displacing mechanism is operated in order to displace the lower mold 52, the first lateral mold 54, the second lateral mold 56, and the upper mold 58 away from each other. Then, the molds are opened to expose the laminated resin molding 44.

As described above, inasmuch as both the first vertical portion 66 and the second vertical portion 68 are filled with the raw material 28, the laminated resin molding 44 is free of any vacancies or void portions therein. In other words, the laminated resin molding 44 is manufactured with an increased yield.

As described above, when a gas such as compressed air or the like is supplied into the cavity 20 in a direction to limit flowing movement of the raw material 28 from the injecting machine 22 and thereby to press the raw material 28, flowing movement in branched portions of the raw material 28 toward the walls of the cavity is accelerated. The cavity 60 is thus filled in a relatively short period of time, and the time required for the raw material 28 to become cured is relatively long. Accordingly, in the raw material 28, which has filled the branched portions, the air bubbles 40 are relatively large in size, and grow substantially equally throughout the entirety of the raw material 28.

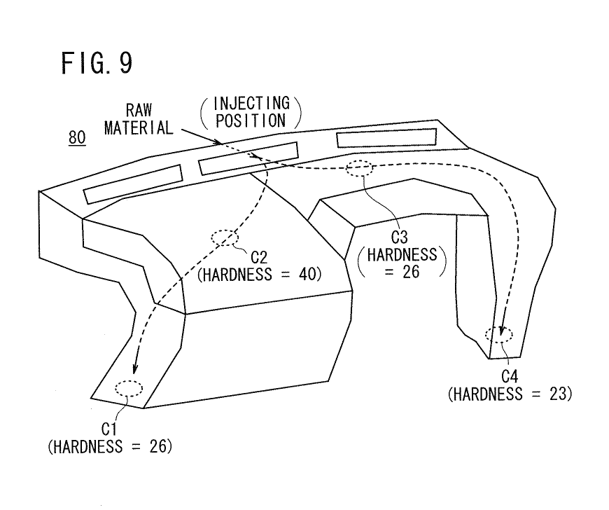

FIG. 9 is a perspective view of a laminated resin molding 80, which has been thus fabricated. In FIG. 9, a polyurethane foam, which makes up the resin foam body 42, is illustrated in an exposed manner.

In FIG. 9, substantially central regions (so-called core regions) in the thickness direction, denoted respectively by broken-line circles C1 through C4, had Asker C hardnesses of 26, 40, 26, 23, respectively. It is obvious from these results that it is possible for the single laminated resin molding 80 to have regions of different hardness therein, which can be formed easily according to the present embodiments.

In FIG. 9, a comparison between C1 and C2 indicates that a region of high hardness and a region of low hardness were present along the direction in which the raw material 28 flows.

According to the second embodiment, as with the first embodiment, open cells can be produced within the resin foam body 42. In other words, it is possible to produce a soft resin foam body 42.

In the first and second embodiments, the cavities 20, 60 have a portion therein that extends horizontally, which has been illustrated by way of example. However, the cavities are not limited to this shape, but may be of any shape.

If a molding having a branched shape, such as a Y-shaped molding, is fabricated, in which each of the branches of the molding have different hardnesses respectively, then the pressure for supplying a gas such as compressed air or the like may be changed. For example, the pressure for supplying the gas into a region of minimum hardness may be maximized, whereas the pressure for supplying the gas into a region of medium hardness may be reduced.

According to such pressure settings, the pressure for supplying a gas, such as compressed air or the like, into a region having uniform medium hardness, or into a region which tends to develop voids therein due to a low filling rate, can be minimized. Further, the pressure for supplying a gas, such as compressed air or the like, into a region of minimum hardness can be increased. Therefore, the rate at which the raw material 28 is supplied into the region having uniform medium hardness, or into the region which tends to develop voids therein due to a low filling rate, can be increased, so that the region can be filled with the raw material 28 in a relatively short period of time. Consequently, hardness can be uniformized at a medium level, and voids within the region can be avoided.

Even if the filling rates are equal to each other, and if there are two or more portions to which the raw material 28 travels different distances from the location where the supply means is positioned, the gas, such as compressed air or the like, may be introduced first toward the portion that would be reached earlier if the raw material 28 were simply introduced into the cavity to fill the cavity, for thereby limiting flowing movement of the raw material 28, and so that the raw material 28 can reach all of the portions at the same time.

Furthermore, the end surface 60a is not limited to being a flat surface, but may be a curved surface. The covering layer 38 is not limited to any particular shape, but may be flat or include curved or bent portions, which are complementary to the shape of the end surface 60a. Similarly, instead of the first vertical portion 66 and the second vertical portion 68, rising portions including curved surfaces that depend on different product shapes may be employed.

1. A method of manufacturing a laminated resin molding by providing a resin foam body on an end surface of a resin-made molding that has been formed to a predetermined shape, and which is placed in a cavity defined by molds, comprising:
while a raw material for the resin foam body is supplied by supply means, supplying a gas to the cavity from a direction that limits flowing movement of the raw material and to press the raw material.

2. A method of manufacturing a laminated resin molding according to claim 1, wherein after the gas has contacted the raw material, a pressure at which the gas is supplied is changed stepwise or continuously.

3. A method of manufacturing a laminated resin molding by providing a resin foam body on an end surface of a resin-made molding that has been formed to a predetermined shape, and which is placed in a cavity defined by molds, comprising:
when a gas is supplied to the cavity to press a raw material supplied thereto from supply means while the supplied raw material flows into the cavity, initiating supply of the gas under a pressure capable of stopping the raw material from flowing; and reducing the pressure of the gas to defoam the raw material while the raw material undergoes foaming.

4. A method of manufacturing a laminated resin molding by providing a resin foam body on an end surface of a resin-made molding that has been formed to a predetermined shape, and which is placed in a cavity defined by molds, comprising the steps of:
using the cavity as the molds, the cavity including a first portion into which a raw material of the resin foam body flows from a location where supply means for supplying the raw material to the cavity is disposed, and a second portion into which the raw material flows from the location in a direction different from the direction in which the raw material flows into the first portion, the raw material having a higher filling rate in the second portion than in the first portion;
supplying a gas to the second portion to press the raw material flowing into the second portion when the raw material is supplied from the supply means, thereby limiting flowing movement of the raw material into the second portion; and
stopping the gas from being supplied after the first portion has been filled with the raw material.

5. A method of manufacturing a laminated resin molding according to claim 4, wherein the pressure for supplying the gas is reduced stepwise or continuously while the first portion is filled with the raw material.

6. A laminated resin molding including a laminated stack of a base layer made of a resin material, an intermediate layer made of a resin foam body, and a covering layer made of a resin material, wherein
the intermediate layer is made of the same resin in its entirety;
the intermediate layer includes a first region including large air bubbles, and a second region including small air bubbles which are smaller in volume than the large air bubbles;
the first region and the second region extend along a direction in which the raw material flows; and
the first region is softer than the second region.

7. A laminated resin molding according to claim 6, wherein the first region has an Asker C hardness ranging from 23 to 26, and the second region has an Asker C hardness ranging from 26 to 40.

8. A laminated resin molding including a laminated stack of a base layer made of a resin material, an intermediate layer made of a resin foam body, and a covering layer made of a resin material, wherein
the intermediate layer is made of the same resin in its entirety; and
the intermediate layer includes air bubbles comprising open cells joined together by cracks.

9. An apparatus for manufacturing a laminated resin molding by providing a resin foam body on an end surface of a resin-made molding that has been formed to a predetermined shape, and which is placed in a cavity defined by molds, comprising:
raw material supply means for supplying a raw material of the resin foam body;
gas supply means for supplying a gas to the cavity in a direction to limit flowing movement of the raw material while the raw material is supplied;
gas pressure changing means for changing a pressure of the gas which is supplied from the gas supply means; and
control means for instructing the gas pressure changing means to change the pressure.

10. (canceled)
